(19) United States
(12) Patent Application Publication
(10) Pub. No.: US 2023/0093803 A1
(43) Pub. Date: Mar. 30, 2023

(54) DRIVER FOR NAIL ANCHOR

(71) Applicant: Steven Scott VALDEZATE, Kellyville Ridge, New South Wales (AU)

(72) Inventor: Steven Scott VALDEZATE, Kellyville Ridge, New South Wales (AU)

(21) Appl. No.: 17/800,512

(22) PCT Filed: Feb. 17, 2021
(86) PCT No.: PCT/IB2021/051345

§ 371 Date: Aug. 17, 2022

(30) Foreign Application Priority Data
Feb. 17, 2020 (AU) 2020900449

(51) Int. Cl. B25D 17/02; B25D 17/08

(52) U.S. Cl. CPC B25D 17/02; B25D 17/08

(57) ABSTRACT

A driver for a nail anchor includes an elongate tool body having a driven end and an opposite nail-driving end. The nail-driving end includes a convexly rounded end of the tool body enabling the driver to drive a nail even when not axially aligned with the nail. The nail-driving end also includes a skirt portion extending around the rounded end to limit lateral displacement of the nail-driving end of the tool body relative to a head of the nail as the driver drives the nail.

This application is the U.S. national phase of International Application No. PCT/IB2021/051345 filed Feb. 17, 2021 which designated the U.S. and claims priority to Australian Patent Application No. 2020900449 filed Feb. 17, 2020, the entire contents of each of which are hereby incorporated by reference.

### FIELD OF THE INVENTION

The present invention relates to nail anchors of the type used for securing a fixture to concrete or similar material such as masonry, brick and rock, and is particularly concerned with a driver or punch to assist setting the nail anchor in the material.

Throughout the specification, unless the context requires otherwise, the word “comprise” or variations such as “comprises” or “comprising”, will be understood to imply the inclusion of a stated integer or group of integers but not the exclusion of any other integer or group of integers.

### BACKGROUND ART

The following discussion of the background art is intended to facilitate an understanding of the present invention only. It should be appreciated that the discussion is not an acknowledgement or admission that any of the material referred to was part of the common general knowledge as at the priority date of the application.

Nail anchors for use in materials such as concrete commonly comprise an expandable sleeve that is closely received in a bore drilled or otherwise formed in the material and a nail that is driven into the sleeve to expand the sleeve laterally outwardly so that the sleeve securely engages the bore wall. The sleeve may have an anchor head to limit the insertion of the sleeve into the bore and/or to receive the fixture between the anchor head and the material.

The nail may be driven into the sleeve by direct manual action of a hammer, but in more recent times, drivers have become known. These are used between a manually held hammer and the nail or, for example, between a powered hammer such as a hammer drill, and the nail. Drivers are also known that incorporate a percussion device into a driven end of the driver for driving a nail-driving end as the driver is held manually. Examples of all of these types of drivers are given in the following prior art patent specifications: US2010264191, US2005051596, US2003000991, U.S. Pat. Nos. 6,585,143, 5,979,913, 5,030,043, 4,867,249, 4,525,111 and 4,007,795, the contents of all of which are incorporated herein by reference.

The present invention is concerned with nail anchor drivers of all of the aforementioned types.

A disadvantage of many previously proposed nail anchor drivers is that they are designed to drive the nail of the nail anchor in axial alignment with the nail, which is not always practical, and/or that the driver may slide off the nail head during the driving action.

It would be very desirable to provide an improved nail anchor in which the aforementioned disadvantages are alleviated.

### DISCLOSURE OF THE INVENTION

According to the present invention, there is provided a driver for a nail anchor, the driver comprising an elongate tool body having a driven end and an opposite nail-driving end, wherein the nail-driving end comprises a convexly rounded end of the tool body enabling the driver to drive a nail even when not axially aligned with the nail, and further wherein the nail-driving end comprises a skirt portion extending around the rounded end to limit lateral displacement of the nail-driving end of the tool body relative to a head of the nail as the driver drives the nail.

In one embodiment, the rounded end is centrally disposed within the skirt portion and on the axis of the elongate tool body.

In one embodiment, the rounded end has a circular cross-section. This enables the driver to be used at any angular orientation. The maximum cross-sectional diameter may be in a range of, for example, about 3 mm to about 7 mm, such as about 5 mm.

In another embodiment, the rounded end is of constant radius to facilitate driving a nail at different angles. The radius may be in a range of about 2 mm to about 3 mm, for example about 2.5 mm.

In a further embodiment, the rounded end has a height in the range of about 1 mm to about 2 mm, for example about 1.5 mm.

In still a further embodiment, the skirt portion extends longitudinally beyond the rounded end a distance commensurate to the axial depth of the nail anchor head. This helps in mitigating the risk of the rounded end sliding entirely off the nail head and preventing penetration or excessive penetration of the nail and anchor heads into the substrate or fixture that it is affixing into the substrate as the underside of the nail head comes into juxtaposition with anchor head and the underside of the anchor head comes into juxtaposition with the substrate or fixture. It may also allow the anchor head to be accommodated within the skirt portion as the nail is fully driven into the sleeve, if the skirt portion has sufficient transverse area to circumscribe same. The longitudinal extension beyond the base of the rounded portion may be in a range of about 4 mm to about 5 mm, for example about 4.5 mm.

The skirt portion may extend continuously around the rounded end. This is not essential though to maintaining engagement between the rounded end and the head of a nail as the same advantage can be achieved with interruptions in the skirt portion. For the same reason the distal end of the skirt portion need not be planar.

In another embodiment, the skirt portion has an internal wall that is circular in cross-section, or at least partly circular if the aforementioned interruptions are present. The external wall may be cylindrical, but other configurations may be adopted if desired.

In a further embodiment, the skirt portion tapers in thickness from a base of the rounded end towards a distal end of the tool body. This may save weight in the driver and can help to centralise the nail-driving end over the nail anchor.

In still a further embodiment, the skirt portion is sized laterally to accommodate an anchor head of the nail anchor as the nail is driven fully into the sleeve. For this purpose, the minimum cross-sectional dimension between the confronting faces of the skirt portion should be about 12 mm. A larger cross-sectional dimension may be adopted but is generally unnecessary unless the driver will be used with nail anchors having larger sleeve heads.

The configuration of the driven end of the tool body and any body portion between the driven end and the nail-driving end will be a function, at least in part, of how the nail-driving end is to be driven, for example whether the driving is by an internal percussion system, by a manually-driven hammer or by a hammer drill. In the case of the driver being used with a hammer drill, the driven end may have a length and cross-section to enable it to be received in the chuck of the drill, or it may be hollow so as to be received over a drill bit (for example the drill bit that is used to form the bore for the nail anchor).

In another embodiment, the driver driven end is adapted to be received in the chuck of a rotary hammer drill and has a smaller cross-section than the nail-driving end. In this embodiment, the driven end may have a cross-sectional dimension that is commensurate to the diameter of a standard special direct system (SDS) shaft for a rotary hammer drill. There are three standard sizes of SDS: SDS-plus (or SDSplus or SDS+), SDS-Top and SDS-max. SDS-plus is the most common by count of tools manufactured, with masonry drills from 4 mm diameter to 30 mm (and from 5/32″ to 1¼″) diameter ordinarily available. The diameter of an SDS and SDS Plus shank is 10 millimeters. (The SDS Max is 18 millimeters.) In the present embodiment an SDS plus shaft is used having a diameter of about 10 mm, and an overall length in the range of about 95 mm to about 100 mm, for example about 98 mm.

Other types of driven end are known, for example as described in the aforementioned prior art patent specifications.

### BRIEF DESCRIPTION OF THE DRAWINGS

The invention will be better understood in light of the following description of the best mode for carrying out the invention. The description is made with reference to the following drawings that consist of various views according to one embodiment of the present invention.

FIG. 1 is an elevational side view of one embodiment of a nail anchor driver according to the invention.

FIG. 2 is a perspective view from the nail-driving end of the one embodiment of the nail anchor driver, also showing a nail anchor.

FIG. 3 is a sectional view of the nail-driving end of the one embodiment of the nail anchor driver.

FIG. 4 is an end view of the nail-driving end of the one embodiment of the nail anchor driver.

FIGS. 5a, 5b, 5c and 5d are a series of schematic side views showing:
the initial drilling of a bore in the substrate using a masonry drill bit (FIG. 5A), and alternative angular orientations of the driver in use during progressive driving of a nail into a nail anchor sleeve and into the bore of the substrate (FIGS. 5b to 5d).

### BEST MODE(S) FOR CARRYING OUT THE INVENTION

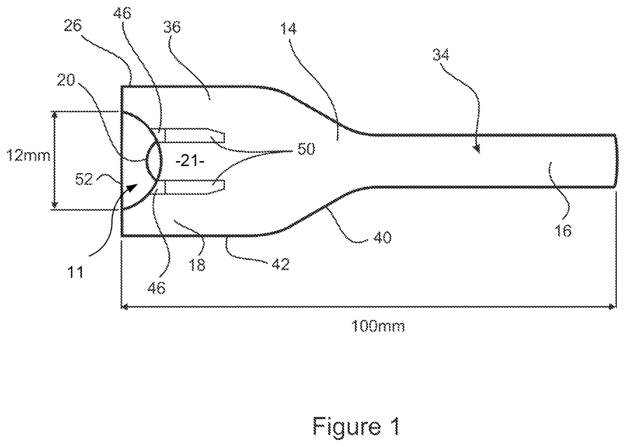

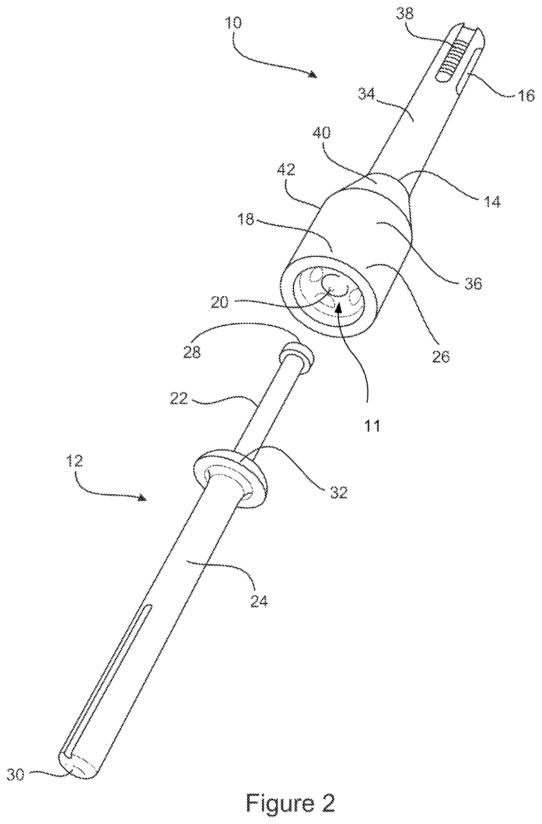

Referring to FIGS. 1 to 4, the one embodiment of the best mode for carrying out the invention involves a driver 10 for a nail anchor 12, the driver comprising an elongate tool body 14 having a driven end 16 and an opposite nail-driving end 18. The nail-driving end 18 comprises a convexly rounded end 20 of the tool body enabling the driver 10 to drive a nail 22 of the nail anchor 12 into a sleeve 24 of the nail anchor even when the driver is not axially aligned with the nail.

The nail-driving end 18 further comprises a skirt portion 26 extending around the convexly rounded end 20 to limit lateral displacement of the nail-driving end 18 of the tool body 14 relative to a flat head 28 of the nail 22 as the driver 10 drives the nail.

The driver 10 may be moulded in metal or alloy such as hardened steel in other embodiments, however in the one embodiment it is moulded in an engineering plastics material such as nylon, or some other light-weight material having commensurate properties to hardened steel.

The driver 10 is designed to be held in the chuck of a hammer drill (not shown) and to drive the nail 22 of the anchor 12 into the sleeve 24 by the hammer action of the drill when the sleeve is received in a bore in a substrate such as concrete in the present embodiment, or wood or other material to which a fixture is to be secured by the anchor. The sleeve 24 is bifurcated along part of its length from a distal end 30 and the action of the nail 22 being driven into the sleeve causes the bifurcated end portion to expand laterally into engagement with the wall of the bore.

The fixture is secured relative to the concrete beneath an anchor head 32 of the sleeve 24.

The driven end 16 of the driver 10 is in the form of part of an elongate shank 34 that extends from an enlarged head portion 36 of the nail-driving end 18. As shown the shank 34 has an overall circular cross-section, but other cross-sections may be adopted in other embodiments, including polygonal. In the present embodiment, the driven end 16 is shaped to conform to the SDS plus shaft configuration relative to the rest of the shank 34 for more secure engagement with the drill chuck, and as shown has four equiangularly spaced longitudinal grooves 38 extending along part of its length (not shown in FIG. 1).

The shank 34 is joined to the head portion 36 of the driver by a tapered portion 40 leading to a cylindrical external wall 42 of the head portion. The overall length of the driver 10 as shown is about 100 mm, of which approximately 70 mm comprises the shank, but longer or shorter drivers may be provided with different length shanks for different nail-anchor driving situations in other embodiments.

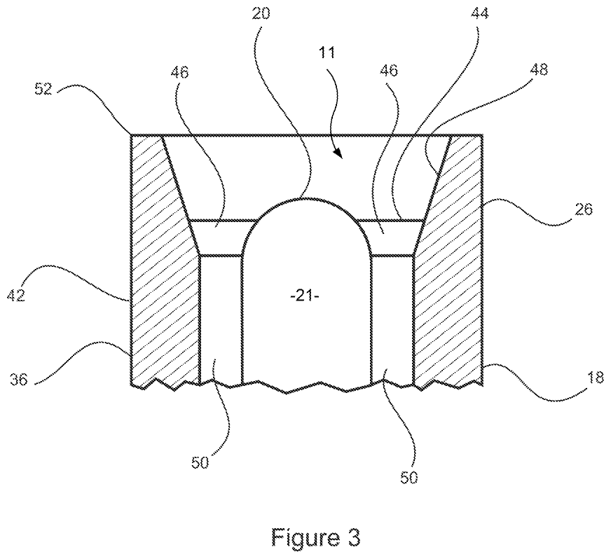

The head portion 36 of the driver 10 incorporates a concave recess 11 defined by the skirt portion 26 with the convexly rounded end 20 disposed at its base, best seen in the sectional view of FIG. 3. A plurality of longitudinally extending cavities 50 are formed within the head portion 36 and are separated by longitudinal webs 46 that define distal lands 44 projecting radially from a central longitudinal stem 21 terminating in the convexly rounded end 20. The cavities 50 help reduce the overall weight of the driver 10.

The convexly rounded end 20 and stem 21 are aligned with the axis of the shank 34 and of the overall driver 10. The rounded end 20 forms a mound having a circular cross-section with a diameter of about 5 mm. The section of the rounded end 20 is arcuate, with a radius of about 5 mm.

The height of the rounded end 20 from a base (or top) of the lands 44 of the skirt portion 26 is about 1.5 mm. This, combined with the sectional radius of the rounded end 20, is sufficient to allow the driver to set the nail anchor 12 at an angular orientation of up to about 30 degrees relative to the axis of the nail anchor.

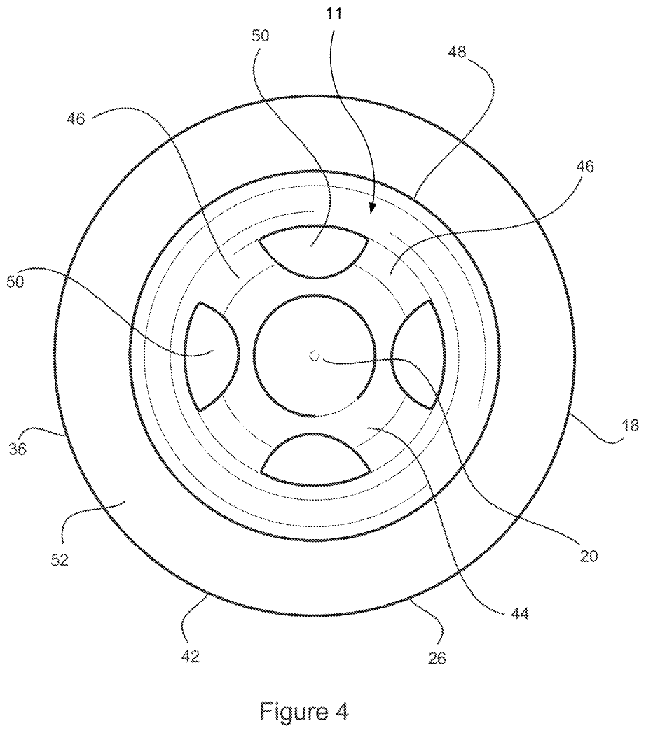

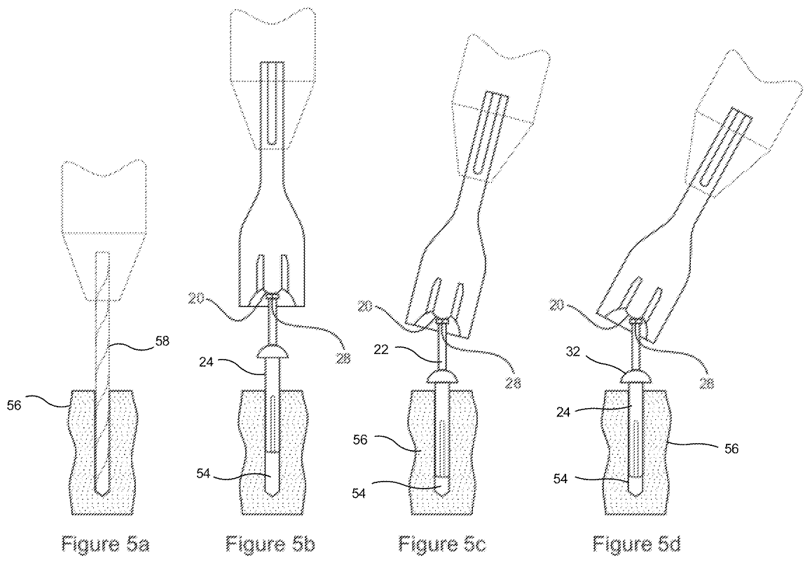

As clearly shown in FIGS. 3 and 4, the lands 44 combine to define the base of the recess 11 circumscribed by the skirt portion 26. In the present embodiment, the webs 46 consist of four equiangularly spaced webs that are provided extending between an internal wall 48 of the skirt portion 26 and the rounded end 20.

The purpose of the webs 46 is to provide radial structural support to the stem 21 when axial and/or angularly displaced percussive forces are applied to the rounded end 20 whilst driving the head 28 of a nail 22 received within the recess 11 of the head portion 36 into position. More or fewer webs are provided in other embodiments, and the depth of the cavities 50 between the webs 46 may be greater than is shown in the present embodiment. In one alternative embodiment, the webs 46 and cavities 50 may be omitted altogether so that the base of the recess 11 defined by the skirt portion 26 is continuous.

The base defined by the lands 44 of the webs 46 is at least substantially planar.

The internal wall 48 of the skirt portion 26 is circular and tapers from the base of the lands 44 to a distal end 52 of the driver 10. As shown the taper in the internal wall 48 extends from the top of the cavities 50 between the webs 46.

The diameter of the circular internal wall 48 of the skirt portion 26 is about 12 mm at the distal end 52, reducing to about 8 mm at the base of the recess 11.

The height or drop of the skirt portion 26, measured from the base level of the rounded end 20 to the distal end 52 of the driver is about 4 mm. Both dimensions are determined as minima to accommodate the anchor head 32 of the nail anchor sleeve 24. Moreover, the skirt portion 26 extends longitudinally beyond the rounded end 20 a distance commensurate to the axial depth of the anchor head. Thus in the present embodiment, the driver is designed for use with nails having an axial head-depth of approximately 2.5 mm to sit within the anchor head 32. Different drivers 10 may be designed to accommodate different nail head depths in other embodiments.

Having a prominent nail and/or anchor head depth and transverse extent with the skirt portion of the nail driving-end designed of sufficient area and depth to accommodate same allows the anchor head 32 of the nail anchor 12 to be accommodated entirely within the skirt portion as the nail is fully driven into the sleeve. This helps in not only mitigating the risk of the rounded end sliding entirely off the nail head, but also with preventing penetration or excessive penetration of the nail and anchor heads into the substrate or fixture that is being affixed to the substrate as the underside of the nail and anchor heads come into juxtaposition with each other and the substrate or fixture.

The distal end 52 of the driver is planar, but this is not necessarily the case in other embodiments. However, the arcuate cut-out illustrated in FIG. 1 is merely a schematic representation of the section of the internal wall 48 of the skirt portion.

FIGS. 5a, 5b, 5c and 5d show how the driver 10 is used. Initially as shown in FIG. 5a, a bore 54 is formed in a substrate 56 using a masonry drill bit 58. After the bore is formed, the driver 10 is then inserted into the drill chuck replacing the masonry bit, or another hammer drill having the driver 10 already fitted is used to with a nail anchor sleeve 24 and nail 22 combination to be inserted into the bore 54.

As can be seen in FIGS. 5b to 5d, the driver 10 can adopt different angular orientations relative to the central axis of a nail 22 for convenience, whilst the nail 22 is being axially driven into a nail anchor sleeve 24 axially aligned with the bore 54 previously drilled in the substrate 56. Accordingly, the shaft of the nail anchor sleeve 24 is progressively expanded as it clampingly engages the side wall of the bore 54 until the head of the nail 22 comes into juxtaposition with the anchor head 32 of the anchor sleeve 24, and the anchor head 32 of the anchor sleeve 24 comes into juxtaposition with the substrate 56 or a fixture being affixed thereto.

Importantly, the driver 10 can adopt different axial positions for convenience whilst simultaneously and continuously applying a percussive axial force to the head 28 of the nail 22 via the rounded end 20 during the driving operation.

While one specific embodiment of the invention, with various alternative modifications, has been described in detail, those skilled in the art will recognize that other and further modifications may be made thereto without departing from the spirit or the scope of the invention. Accordingly, it is intended to claim all such changes and modifications as falling within the scope of the invention.

It is apparent from the above, that the arrangements described are applicable to the building industry as well as to home renovators.

1-15. (canceled)

16. A driver for a nail anchor having a sleeve and anchor head to receive a nail, the driver comprising an elongate tool body having a driven end and an opposite nail-driving end,
the nail-driving end comprises:
(i) a convexly rounded end of the tool body enabling the driver to drive the nail both when axially or not axially aligned with the nail, and
(ii) a skirt portion extending around the rounded end to limit lateral displacement of the nail-driving end of the tool body relative to the head of the nail when the driver is driving the nail;
wherein the skirt portion has an inner wall tapering from a base of the rounded end towards a distal end of the tool body.

17. A driver according to claim 16, wherein the rounded end is centrally disposed within the skirt portion and on the axis of the elongate tool body.

18. A driver according to claim 16, wherein the rounded end has a circular cross-section.

19. A driver according to claim 16, wherein the rounded end is of constant radius.

20. A driver according to claim 16, wherein the skirt portion extends longitudinally beyond the rounded end and incorporates a concave recess with the rounded end disposed at its base.

21. A driver according to claim 16, wherein the skirt portion extends continuously around the rounded end.

22. A driver according to claim 16, wherein the skirt portion has an internal wall that is circular in cross-section.

23. A driver according to claim 16, wherein the skirt portion has an external wail that is circular in cross-section.

24. A driver according to claim 23, wherein the exterior wall of the skirt portion is cylindrical.

25. A driver according to claim 16, wherein the skirt portion is formed with a land circumscribing the rounded end and defining the base.

26. A driver according to claim 25, wherein the land is substantially planar.

27. A driver according to claim 16, wherein the skirt portion is sized to accommodate a proximal end of a sleeve of a nail anchor.

28. A driver according to claim 16, wherein the driven end of the tool body has a smaller cross-section than the nail-driving end.

29. A driver according to claim 16, wherein the driven end of the tool body has a length and cross-section to enable it to be received in a chuck of a hammer drill.

30. A driver according to claim 16, wherein the skirt portion extends longitudinally beyond the rounded end a distance commensurate to the axial depth of the anchor head.
